(19) United States
(12) Patent Application Publication
(10) Pub. No.: US 2015/0047536 A1
(43) Pub. Date: Feb. 19, 2015

(54) TAILGATE-MOUNTED WORK SURFACE

(71) Applicants: Greg Parks, Pataskala, OH (US); John Farrell, Gahanna, OH (US); Doug Strait, Gahanna, OH (US); Michael Farrell, Gahanna, OH (US)

(72) Inventors: Greg Parks, Pataskala, OH (US); John Farrell, Gahanna, OH (US); Doug Strait, Gahanna, OH (US); Michael Farrell, Gahanna, OH (US)

(21) Appl. No.: 14/331,990

(22) Filed: Jul. 15, 2014

Related U.S. Application Data
(63) Continuation of application No. 13/071,903, filed on Mar. 25, 2011, now abandoned.

(51) Int. Cl. B62D 63/04; B62D 33/027

(52) U.S. Cl. CPC B62D 63/04; B62D 33/0273
USPC 108/44; 108/90

(57) ABSTRACT

A portable work surface for use with a vehicle having an extendable rear gate, wherein the rear gate includes first and second latches for securing the rear gate to the body of the vehicle when in a closed position, and wherein the portable work surface includes an elongated platform; a first mounting apparatus attached to one end of the elongated platform, wherein the first mounting apparatus further includes a bracket and pin assembly; a second mounting apparatus attached to the opposite end of the elongated platform, wherein the second mounting apparatus further includes a bracket and pin assembly; and wherein each pin is adapted to cooperate with one of the latches on the rear gate for securely attaching the work surface to the gate when the gate is in the open position.

### CROSS-REFERENCE TO RELATED APPLICATIONS

This patent application claims the benefit of U.S. Non-Provisional patent application Ser. No. 13/071,903 filed on Mar. 25, 2011 and entitled “Tailgate Mounted Work Surface,” and U.S. Provisional Patent Application Ser. No. 61/317,361, filed on Mar. 25, 2010 and entitled “Tailgate Mounted Work Surface,” the disclosure of which is hereby incorporated by reference herein in its entirety and made part of the present U.S. utility patent application for all purposes.

### BACKGROUND OF THE INVENTION

The described invention relates in general to a portable work surface, and more specifically to a portable work surface that detachably mounts on the top surface of the tailgate of a pickup truck or similar vehicle, when the tailgate is in the open position.

Pickup trucks, certain SUVs, and other similar vehicles typically include a bed or cargo area behind the cab of the vehicle that is accessible by opening a hinged gate, commonly referred to as a tailgate. Such utilitarian vehicles are often used to transport tools, equipment, or other work-related items to a worksite. Such vehicles are also used to transport hunting, fishing, and camping gear into the field, or to transport sports-related items or other recreational items as needed or desired. Out of necessity, the tailgate of the vehicle is often used as a work surface of one type or another, despite not having been designed for such a purpose. Because tailgates are not intended to be used as work surfaces, they often do not include a completely level surface and consequently may not provide a stable substrate. Placing a wooden board or heavy piece of cardboard on the top surface of a tailgate may correct surface irregularities, but unless the board (or other flat item) is securely fastened to the tailgate, this temporary work surface is likely to be unstable and even dangerous. Thus, there is an ongoing need for a portable device that may be securely attached to an open tailgate of a pickup truck or similar vehicle for providing a stable substrate that may be used as a work surface for a wide variety of purposes.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a portable work surface is provided. This portable work surface includes a platform; and at least one mounting apparatus attached to or formed integrally with the platform, wherein the at least one mounting apparatus is adapted to cooperate with a latching mechanism mounted on or within a substrate, and wherein the cooperation of the mounting apparatus and latching mechanism is operative to stabilize the platform on or against the substrate.

In accordance with another aspect of the present invention, a portable work surface for use with a vehicle having an extendable rear gate is provided. The rear gate includes first and second latches for securing the rear gate to the body of the vehicle when in a closed position. The portable work surface includes an elongated platform; a first mounting apparatus attached to one end of the elongated platform, wherein the first mounting apparatus further includes a bracket and pin assembly; and a second mounting apparatus attached to the opposite end of the elongated platform, wherein the second mounting apparatus further includes a bracket and pin assembly. Each pin is adapted to cooperate with one of the latches on the rear gate for securely attaching the work surface to the gate when the gate is in the open position.

In yet another aspect of this invention, a portable work surface for use with a vehicle having an extendable rear gate is also provided. The rear gate includes first and second latches for securing the rear gate to the body of the vehicle when in a closed position. The portable work surface comprises an elongated, substantially planar platform, wherein the platform further includes at least one rigid supportive material; a first mounting apparatus attached to one end of the elongated platform, wherein the first mounting apparatus further includes an adjustable bracket and pin assembly; and a second mounting apparatus attached to the opposite end of the elongated platform, wherein the second mounting apparatus further includes an adjustable bracket and pin assembly. Each pin is adapted to cooperate with one of the latches on the rear gate for securely attaching the work surface to the gate when the gate is in the open position.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a perspective view of a portable work surface in accordance with an exemplary embodiment of the present invention, wherein the platform has been detached from the tailgate on which it mounts and to which it attaches when in use;

FIG. 2 is a close-up view of an exemplary mounting apparatus included on the portable work surface of the present invention; and

FIG. 3 is a perspective view of the portable work surface of FIG. 1, just prior to insertion of the right-handed mounting apparatus into the corresponding tailgate latch.

### DETAILED DESCRIPTION OF THE INVENTION

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention provides a substantially level, planar, and mobile (i.e., portable) work surface that snaps (or locks) securely into the open tailgate of a pick-up truck, SUV, or other similar vehicle. This invention includes an attachment and stabilizing system attached to or formed integrally with the planar surface for providing a very stable and secure work or preparation surface on top of a pickup truck tailgate when the tailgate is in the open (i.e., extended) position, and when the vehicle is not in motion. The attachment and stabilizing system locks or snaps into the open gate of a vehicle and prevents the platform from moving side-to-side, front-to-back, tipping or becoming otherwise unstable. With reference now to the Figures, one or more specific embodiments of this invention shall be described in greater detail.

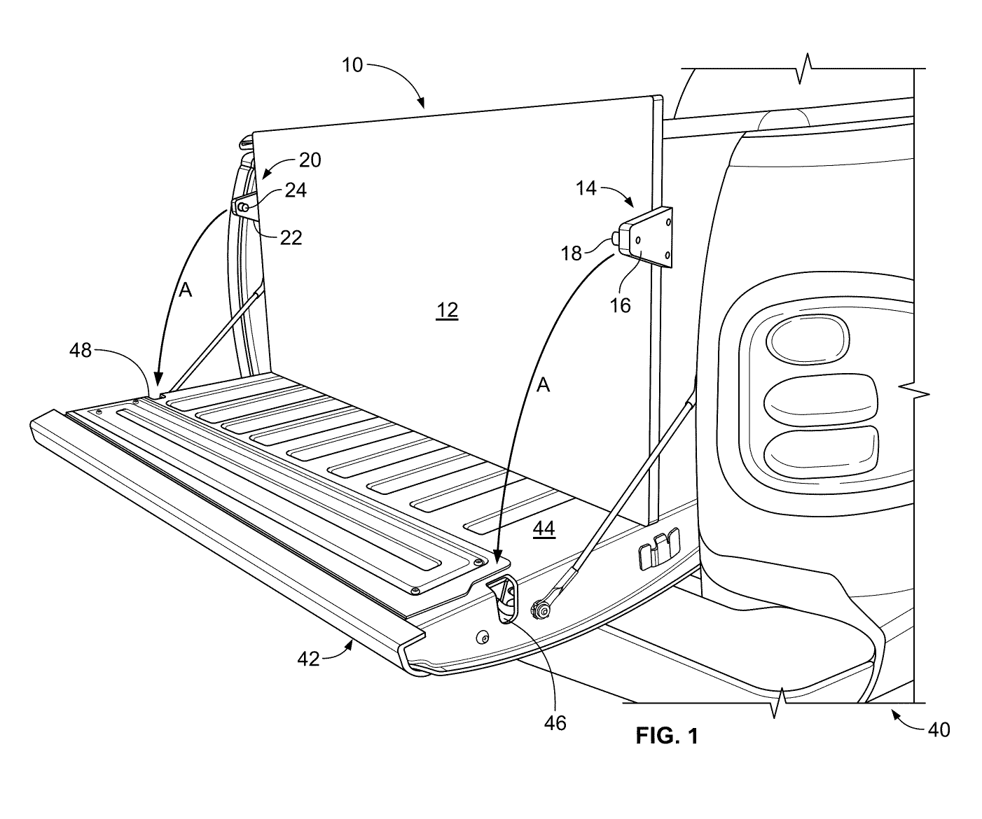

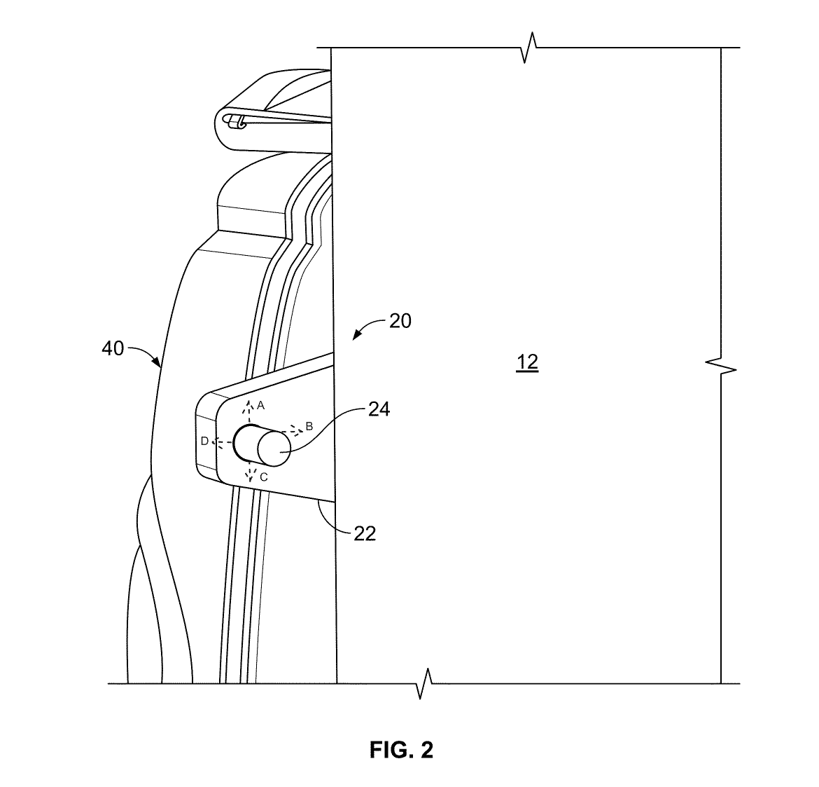

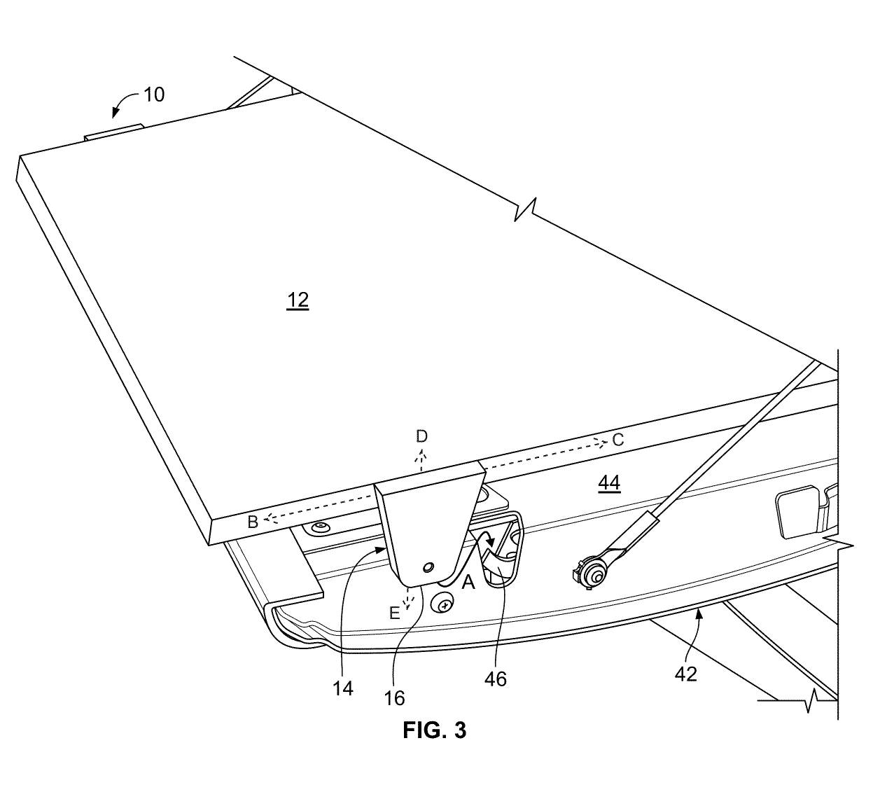

As shown in FIGS. 1-3, an exemplary embodiment of portable work surface 10 includes platform 12, first mounting apparatus 14, and second mounting apparatus 20. First mounting apparatus 14 includes bracket 16, which is mounted on the outside edge of platform 12. Pin 18 is attached to the inside surface of bracket 16 and extends inward in a direction substantially parallel to platform 12. Second mounting apparatus 20 includes bracket 22, which is mounted on the outside edge of platform 12 opposite bracket 16. Pin 24 is attached to the inside surface of bracket 22 and extends inward in a direction substantially parallel to platform 12. Tailgate 42, which is attached to truck 40, further includes upper surface 44, as well as first latch 46 and second latch 48. Latches 46 and 48 are of the type typically included on pickup trucks and the like.

Portable work surface 10 is securely attached to tailgate 42 by placing pins 18 and 25 against latches 46 and 48 respectively and pushing downward to engage the spring-loaded action of the latches in manner similar to the technique used for securing tailgate 42 to the body of truck 40 (i.e., closing the tailgate). To release portable work surface 10 from open tailgate 42, a user simply pulls upward/outward on the tailgate release handle (as one would normally do to release the tailgate from its upright/locked position with the truck bed) and removes the platform from tailgate 42 by lifting upward. Work surface 10 may then be stored in either the bed or cab of the pick-up truck or elsewhere. The various embodiments of this invention function with most existing truck beds and tailgates and do not require modification of either the vehicle's body or of the tailgate itself.

The tailgate-mounted work surface of the present invention may be manufactured from a variety of different materials or combinations of materials including, wood, plastic, metal, and any of a number of different synthetic materials used for countertops or similar surfaces. In one embodiment specific to a 2003 Ford F-150 pick-up truck, the platform component of the tailgate-mounted work surface is 50.25 inches in length by 22 inches in depth (width). Each bracket adds an additional 0.75 inches (1.5 inches total) to the length of the device. Numerous variations in length, depth (width), and thickness are possible with this invention. In some embodiments, one or more compartments, divisions, and/or storage areas are formed in the upward facing surface of platform 12 or within the body of platform 12. A lip or retaining ridge may be formed around the entire perimeter or around a portion of the perimeter of the upper surface of platform 12 in various embodiments of this invention.

In some embodiments of this invention, the components of first mounting apparatus 14 and second mounting apparatus 16 are in fixed positions on either the ends or bottom of platform 12. In other embodiments, the mounting assemblies are vertically adjustable, horizontally adjustable or both, with regard to their placement on platform 12. In still other embodiments, pins 18 and 24 are vertically or horizontally adjustable within brackets 16 and 22 respectively, using springs, rods, brakes, or other mechanical means for securing the pins within the brackets. As will be appreciated by one of ordinary skill in the art, numerous different mechanical means may be employed for conferring adjustability to first mounting apparatus 14 and second mounting apparatus 16 and/or the components thereof. Adjustability of these components allows portable work surface 10 to be used with tailgates of different sizes and dimensions. Finally, in certain embodiments, platform 12 is adjustable or partially collapsible to allow portable work surface 10 to be used with a variety of vehicles and tailgates.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

1-20. (canceled)

21. A portable work surface for use with a vehicle having an extendable rear gate, wherein the extendable rear gate includes first and second latches for securing the rear gate to the body of the vehicle, and wherein the portable work surface comprises:
(a) an elongated, substantially level and planar platform having a front edge, a rear opposite the front edge, a first or left side, and a second or right side opposite the left side; wherein the platform, when in use, is positioned atop and parallel to the rear gate of a vehicle when the rear gate is extended; wherein the platform further includes at least one rigid supportive material; and wherein the platform is operative to provide a stable work surface for supporting items capable of being transported in the vehicle, including tools, hunting and fishing equipment, and camping gear;
(b) a first mounting apparatus on the left side of the elongated platform, wherein the first mounting apparatus is vertically and horizontally adjustable with regard to its placement on the platform, wherein the first mounting apparatus further includes a bracket and pin assembly, and wherein the pin in the bracket and pin assembly is adapted to cooperate with the first latch on the rear gate for securely attaching the work surface to the gate when the gate is in an open position;
(c) a second mounting apparatus on the right side of the elongated platform, wherein the second mounting apparatus is vertically and horizontally adjustable with regard to its placement on the platform, wherein the second mounting apparatus further includes a bracket and pin assembly, and wherein the pin in the bracket and pin assembly is adapted to cooperate with the second latch on the rear gate for securely attaching the work surface to the gate when the gate is in an open position; and
(d) wherein the adjustability of the first and second mounting apparatuses is operative to allow the portable work surface to be used with extendable rear gates of different sizes and dimensions.

22. The portable work surface of claim 21, wherein the vehicle is a pickup truck or an SUV.

23. The portable work surface of claim 21, wherein the platform further includes at least one compartment, division, storage area, or combinations thereof formed in the upward facing surface thereof or within the body thereof.

24. The portable work surface of claim 21, wherein the platform further includes a retaining ridge formed partially or entirely around the upward facing surface thereof

25. The portable work surface of claim 21, wherein the platform is partially collapsible, and wherein the collapsibility of the platform is operative to allow the portable work surface to be used with a variety of vehicles and tailgates.

26. The portable work surface of claim 21, wherein the at least one rigid supportive material is wood, plastic, metal, or a synthetic building material.

27. A portable work surface for use with a vehicle having an extendable rear gate, wherein the extendable rear gate includes first and second latches for securing the rear gate to the body of the vehicle, and wherein the portable work surface comprises:
(a) an elongated, substantially level and planar platform having a front edge, a rear opposite the front edge, a first or left side, and a second or right side opposite the left side; wherein the platform, when in use, is positioned atop and parallel to the rear gate of a vehicle when the rear gate is extended; wherein the platform further includes at least one rigid supportive material; wherein the platform is operative to provide a stable work surface for supporting items capable of being transported in the vehicle, including tools, hunting and fishing equipment, and camping gear; and wherein the platform is partially collapsible;
(b) a first mounting apparatus on the left side of the elongated platform, wherein the first mounting apparatus is vertically and horizontally adjustable with regard to its placement on the platform, wherein the first mounting apparatus further includes a bracket and pin assembly, and wherein the pin in the bracket and pin assembly is adapted to cooperate with the first latch on the rear gate for securely attaching the work surface to the gate when the gate is in an open position;
(c) a second mounting apparatus on the right side of the elongated platform, wherein the second mounting apparatus is vertically and horizontally adjustable with regard to its placement on the platform, wherein the second mounting apparatus further includes a bracket and pin assembly, and wherein the pin in the bracket and pin assembly is adapted to cooperate with the second latch on the rear gate for securely attaching the work surface to the gate when the gate is in an open position; and
(d) wherein the adjustability of the first and second mounting apparatuses is operative to allow the portable work surface to be used with extendable rear gates of different sizes and dimensions.

28. The portable work surface of claim 27, wherein the vehicle is a pickup truck or an SUV.

29. The portable work surface of claim 27, wherein the platform further includes at least one compartment, division, storage area, or combinations thereof formed in the upward facing surface thereof or within the body thereof.

30. The portable work surface of claim 27, wherein the platform further includes a retaining ridge formed partially or entirely around the upward facing surface thereof.

31. The portable work surface of claim 27, wherein the at least one rigid supportive material is wood, plastic, metal, or a synthetic building material.

32. A portable work surface for use with a vehicle having an extendable rear gate, wherein the extendable rear gate includes first and second latches for securing the rear gate to the body of the vehicle, and wherein the portable work surface comprises:
(a) an elongated, substantially level and planar platform having a front edge, a rear opposite the front edge, a first or left side, and a second or right side opposite the left side; wherein the platform, when in use, is positioned atop and parallel to the rear gate of a vehicle when the rear gate is extended; wherein the platform further includes at least one rigid supportive material; wherein the platform is operative to provide a stable work surface for supporting items capable of being transported in the vehicle, including tools, hunting and fishing equipment, and camping gear; wherein the platform is partially collapsible; and wherein the platform further includes a retaining ridge formed partially or entirely around the upward facing surface thereof;
(b) a first mounting apparatus on the left side of the elongated platform, wherein the first mounting apparatus is vertically and horizontally adjustable with regard to its placement on the platform, wherein the first mounting apparatus further includes a bracket and pin assembly, and wherein the pin in the bracket and pin assembly is adapted to cooperate with the first latch on the rear gate for securely attaching the work surface to the gate when the gate is in an open position;
(c) a second mounting apparatus on the right side of the elongated platform, wherein the second mounting apparatus is vertically and horizontally adjustable with regard to its placement on the platform, wherein the second mounting apparatus further includes a bracket and pin assembly, and wherein the pin in the bracket and pin assembly is adapted to cooperate with the second latch on the rear gate for securely attaching the work surface to the gate when the gate is in an open position; and
(d) wherein the adjustability of the first and second mounting apparatuses is operative to allow the portable work surface to be used with extendable rear gates of different sizes and dimensions.

33. The portable work surface of claim 32, wherein the vehicle is a pickup truck or an SUV.

34. The portable work surface of claim 32, wherein the platform further includes at least one compartment, division, storage area, or combinations thereof formed in the upward facing surface thereof or within the body thereof.

35. The portable work surface of claim 32, wherein the at least one rigid supportive material is wood, plastic, metal, or a synthetic building material.
